(19) United States
(12) Patent Application Publication
(10) Pub. No.: US 2014/0379225 A1
(43) Pub. Date: Dec. 25, 2014

(54) LIGHT DISTRIBUTION CONTROL SYSTEM FOR VEHICULAR HEADLAMP

(71) Applicant: KOITO MANUFACTURING CO., LTD., Tokyo (JP)

(72) Inventor: Yutaka NAKANISHI, Shizuoka-shi (JP)

(73) Assignee: KOITO MANUFACTURING CO., LTD., Tokyo (JP)

(21) Appl. No.: 14/310,183

(22) Filed: Jun. 20, 2014

(30) Foreign Application Priority Data
Jun. 21, 2013 (JP) 2013-130205

(51) Int. Cl. B60Q 1/08; B60Q 1/12; B60Q 1/10

(52) U.S. Cl. CPC B60Q 1/08; B60Q 1/10; B60Q 1/12
USPC 701/49

(57) ABSTRACT

A light distribution control system for a vehicular headlamp includes a headlamp configured such that light distribution of the headlamp can be controlled based on a plurality of modes of light distribution control, and a light distribution control electronic control unit configured to control the light distribution of the headlamp based on at least one of the plurality of modes of light distribution control. The light distribution control electronic control unit is configured such that a common unit commonly used in the plurality of modes of the light distribution control and a dedicated unit exclusively used in at least one of the plurality of modes of the light distribution control can be mounted.

### INCORPORATION BY REFERENCE

The disclosure of Japanese Patent Application No. 2013-130205 filed on Jun. 21, 2013 including the specification, drawings and abstract is incorporated herein by reference in its entirety.

### BACKGROUND OF THE INVENTION

1. Field of the Invention

This invention relates to a light distribution control system configured to control light distribution of a vehicular headlamp.

2. Description of Related Art

Up until now, light distribution control means for controlling the light distribution of headlamps has been proposed to enhance visibility in the front illumination areas illuminated by the headlamps of host vehicle and prevent the occupants of leading and oncoming vehicles existing in the front illumination areas from being dazzled. For example, as the light distribution control means leveling control means, swivel control means, and light distribution pattern control means have been proposed. The leveling control means deflects the lamp light axis of a headlamp in an up and down direction with a change in the angle of the forward and backward tilting of the body of a vehicle and controls the direction of the lamp light axis to be constant with respect to a road surface. The swivel control means deflects the lamp light axis of a head lamp in a right and left direction with the steering of a vehicle in the right and left direction and controls the lamp light axis to be directed to a running direction of the vehicle. The light distribution pattern control means selectively interrupts some of a light distribution pattern radiated from a head lamp to prevent the occupants of leading and oncoming vehicles from being dazzled.

It has also been proposed that the three light distribution control means described above are appropriately combined together to construct light distribution control systems for vehicles. For example, an auto leveling light distribution control system (hereinafter referred to as an auto leveling system (ALS) in the specification) using only the leveling control means, a light distribution control system referred to as an adaptive front-lighting system (AFS) in which the leveling control means and the swivel control means are combined together, and a light distribution control system referred to as an adaptive driving beam (ADB) in which the AFS is combined with the light distribution pattern control means have been proposed as such. The ALS and the AFS are the light distribution control systems that control the direction of a lamp light axis. The ADB changes the shape of light radiated from a head lamp with light distribution pattern control. Therefore, with the ADB, it becomes possible to perform light distribution control in which the occupants of other vehicles are effectively prevented from being dazzled and an illumination area in front of a host vehicle is increased as large as possible. In Japanese Patent Application Publication No. 2011-16504 (JP 2011-16504 A), leveling actuators, swivel actuators, and variable shade mechanisms are disposed inside right and left headlamps on the front right and left sides of a vehicle and are controlled by a light distribution control electronic control unit (ECU) (light distribution control ECU). Thus, leveling control, swivel control, and light distribution pattern control for the headlamps are performed, and ADB control is performed by the combination of such control.

Meanwhile, as light distribution control systems for the headlamps of vehicles in recent years, any of the ALS that performs only the leveling control, the AFS in which the leveling control and the swivel control are combined together, and the ADB in which the leveling control, the swivel control, and light distribution pattern control are combined together is selected and mounted on the vehicles depending on differences in the types and grades of the vehicles. Therefore, dedicated light distribution control ECUs are manufactured corresponding to the differences between the light distribution control systems mounted on the vehicles, i.e., corresponding to the ALS, the AFS, and the ADB and mounted on the vehicles. Accordingly, it is necessary to design and manufacture the dedicated light distribution control ECUs having different configurations corresponding to the respective light distribution control systems, and thus the manufacturing costs of the light distribution control systems become high. In addition, if the respective light distribution control ECUs are designed to be optimized, the standards of the sizes of the casings of the light distribution control ECUs, the sizes of circuit boards disposed inside the casings, the number of connector electrodes, or the like are likely to be different between the light distribution control ECUs. In this case, the compatibility between the respective light distribution control ECUs may not be obtained, which is unfavorable in terms of maintenance.

### SUMMARY OF THE INVENTION

This invention provides a low-cost light distribution control system for a vehicular headlamp.

An aspect of the invention relates to a light distribution control system for a vehicular headlamp including: a headlamp configured such that light distribution of the headlamp can be controlled based on a plurality of modes of light distribution control; and a light distribution control electronic control unit configured to control the light distribution of the headlamp based on at least one of the plurality of modes of light distribution control. The light distribution control electronic control unit is configured such that a common unit commonly used in the plurality of modes of the light distribution control and a dedicated unit exclusively used in at least one of the plurality of modes of the light distribution control can be mounted.

According to the aspect of the invention, a plurality of different modes of the light distribution control can be realized without mounting or only by selectively mounting a dedicated unit on a light distribution control ECU having the same configuration. Therefore, it is not necessary to design and manufacture light distribution control ECUs having different configurations corresponding to the plurality of different modes of the light distribution control, and thus the light distribution control ECUs can be manufactured easily and at low cost.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1A is a schematic perspective view of a vehicle to which a light distribution control system according to an embodiment of the invention is applied;

FIG. 1B is an internal configuration view of a vehicular headlamp;

FIG. 2 is a block configuration diagram of a light distribution control system constructed as ADB;

FIG. 3 is a block configuration diagram of a light distribution control system constructed as AFS;

FIG. 4 is a block configuration diagram of a light distribution control system constructed as ALS; and

FIG. 5 is a block configuration diagram illustrating the connection between a light distribution control ECU and a controller area network (CAN) signal line to describe the update of an application in a light distribution control ECU.

### DETAILED DESCRIPTION OF EMBODIMENTS

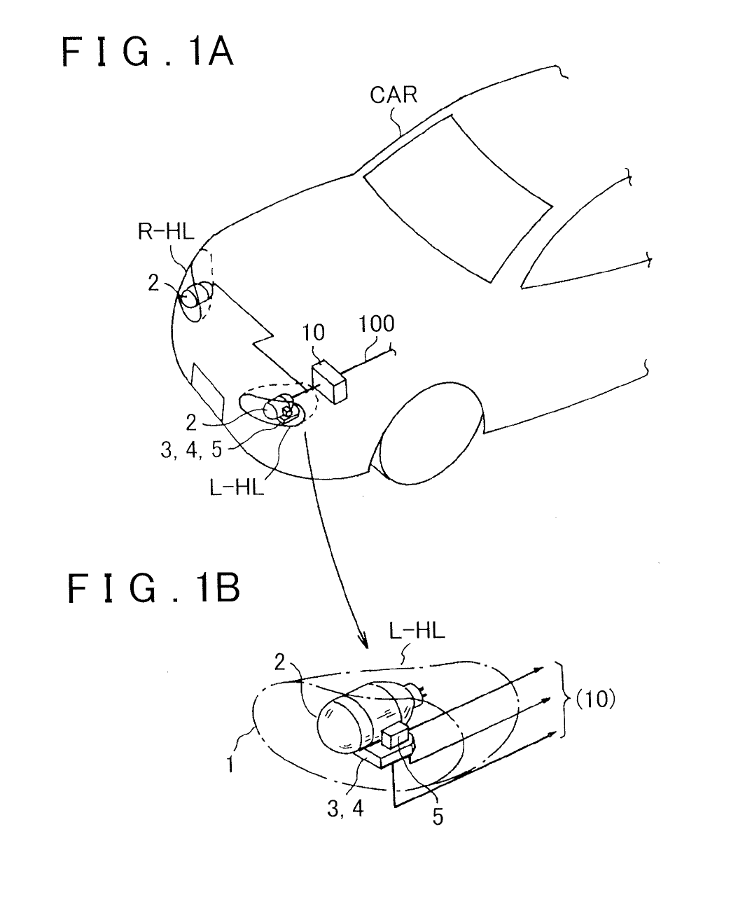

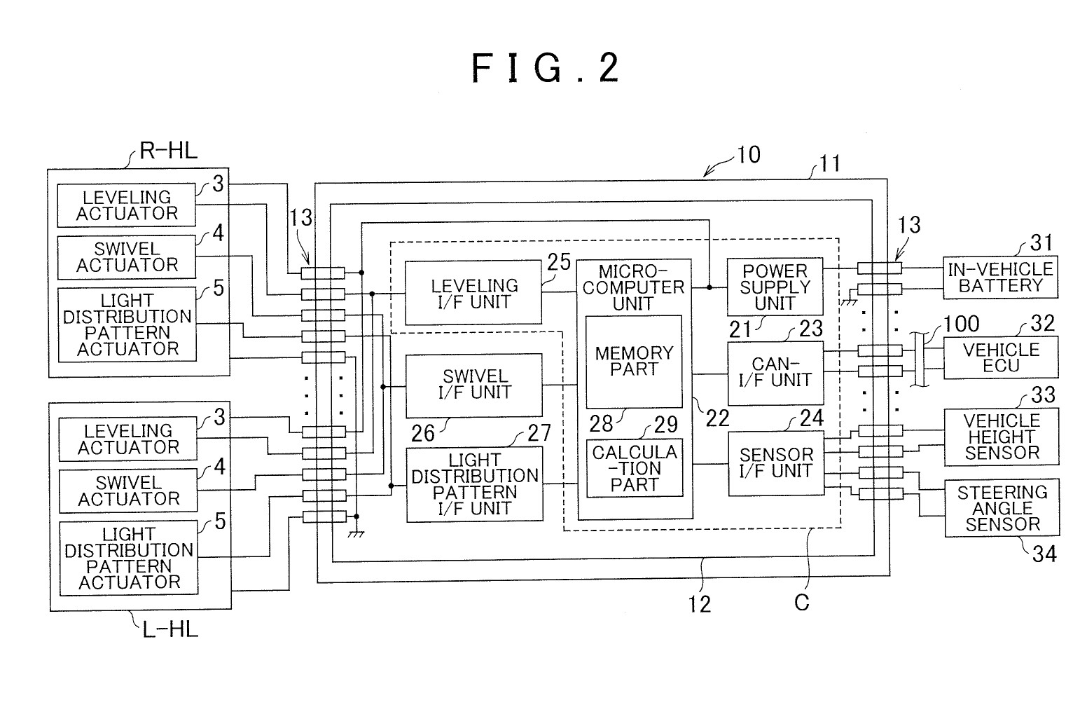

A description will be given of an embodiment of the invention with reference to the drawings. FIG. 1A is a conceptual configuration view of headlamps to which the embodiment of the invention is applied. The headlamps include a right head lamp R-HL and a left head lamp L-HL, respectively, disposed on the right side and the left side of the front of the body of a vehicle (“CAR” in the figure). The right and left headlamps R-HL and L-HL have nearly the same configuration. As illustrated by an enlarged view in FIG. 1B, the left head lamp L-HL has a projector lamp unit 2 disposed inside a lamp housing 1 schematically indicated by a chain line. Inside the lamp housing 1, a leveling actuator 3, a swivel actuator 4, and a shade actuator 5 are incorporated to control the light distribution of the lamp unit 2. The leveling actuator 3 tilts the lamp light axis of the lamp unit 2 in a vertical up and down direction, and the swivel actuator 4 tilts the lamp light axis in a horizontal right and left direction. Here, the leveling actuator 3 and the swivel actuator 4 are integrated as one actuator. In addition, the shade actuator 5 switches a shade (not illustrated) disposed inside the lamp unit 2 to change the shape of light emitted from the lamp unit 2. The shade actuator 5 functions as a light distribution pattern actuator (hereinafter referred to as a light distribution patter 5). As is seen with reference to FIG. 2, the right head lamp R-HL also includes the leveling actuator 3, the swivel actuator 4, and the shade actuator 5.

The headlamps R-HL and L-HL perform light distribution control based on the ALS, the AFS, and the ADB described above. The ALS drives and controls only the leveling actuator 3 to control a light distribution pattern formed by the lamp unit 2 to be deflected in the vertical up and down direction. The AFS drives and controls the leveling actuator 3 and the swivel actuator 4 in their coordinated fashion to control a light distribution pattern formed by the lamp unit 2 to be deflected in the vertical up and down direction and the horizontal right and left direction. The ADB drives and controls the light distribution pattern actuator 5 to change the shape of a light distribution pattern formed by the lamp unit 2, and also drives and controls one or both of the leveling actuator 3 and the swivel actuator 4 in their coordinated fashion to change the shape of the light distribution pattern formed by the lamp unit 2 and control the light distribution pattern to be deflected in the vertical up and down direction and the horizontal right and left direction.

As illustrated in FIG. 2, both of the headlamps R-HL and L-HL include the leveling actuator 3, the swivel actuator 4, and the light distribution pattern actuator 5 and are connected to a light distribution control ECU 10 that drives and controls each of the actuators 3, 4, and 5. FIG. 2 is a system block diagram containing the light distribution control ECU 10 and the right and left headlamps R-HL and L-HL. FIG. 2 illustrates an example in which the ADB is constructed as a light distribution control system in the embodiment. The light distribution control ECU 10 has a casing 11 formed in a prescribed size and shape, and a motherboard 12 formed to be separated from the casing 11 is disposed inside the casing 11 as a circuit board. The motherboard 12 is composed of an insulating board having a prescribed shaped and size on which a prescribed conductive circuit pattern is formed, and various electronic components are mounted on the motherboard 12 to configure a plurality of circuit units. Here, a power supply unit 21, a microcomputer unit 22, a CAN interface (I/F) unit (CAN-I/F unit) 23, a sensor I/F unit 24, a leveling I/F unit 25, a swivel I/F unit 26, and a light distribution pattern I/F unit 27 are configured as such. In addition, connecter electrodes 13 under a prescribed standard are disposed on the casing 11 and the motherboard 12. By the connector electrodes 13, the casing 11 and the motherboard 12 are electrically connected to each other. Moreover, by the connector electrodes 13, the light distribution control ECU 10 is electrically connected to various devices, here, external devices that will be described later.

The power supply unit 21 configured on the motherboard 12 is electrically connected via the connector electrodes 13 to an in-vehicle battery 31 that serves as an external device and supplies power to the microcomputer unit 22 and each of the actuators 3, 4, and 5 after receiving the power from the in-vehicle battery 31. As will be described in detail later, the microcomputer unit 22 includes a memory part 28 that stores control software (application) and a calculation part 29 that operates with the software and generates respective control signals for leveling control, swivel control, and light distribution pattern control based on signals input from the CAN-I/F unit 23 and the sensor I/F unit 24. Each of the leveling I/F unit 25, the swivel I/F unit 26, and the light distribution pattern I/F unit 27 is connected to the microcomputer unit 22 and also connected via the connector electrodes 13 to each of the leveling actuators 3, the swivel actuators 4, and the light distribution pattern actuators 5 of the right and left headlamps R-HL and L-HL. Based on the respective control signals for the leveling control, the swivel control, and the light distribution pattern control output from the microcomputer unit 22, the leveling I/F unit 25, the swivel I/F unit 26, and the light distribution pattern I/F unit 27 output drive signals for driving the leveling actuators 3, the swivel actuators 4, and the light distribution pattern actuators 5, respectively.

The CAN I/F unit 23 is connected via the connector electrodes 13 to a CAN signal line 100 provided in the body of the vehicle and connected via the CAN signal line 100 to a vehicle ECU 32 that serves as an external device. Via the CAN signal line 100, a CAN signal for turning on and off each of the headlamps R-HL and L-HL is input to the CAN-I/F unit 23. For example, a turning on/off signal from a switch operated when a driver turns on and off the headlamps is input as the CAN signal. The sensor I/F unit 24 is connected via the connector electrodes 13 to various sensors serving as external devices that detect a running status of the vehicle. Here, a vehicle height sensor 33 that detects a change in the vehicle height of the vehicle and a steering angle sensor 34 that detects a steering direction of the vehicle are connected to the sensor OF unit 24 as such and input a vehicle height detection signal and a steering angle detection signal, respectively. In addition, the leveling I/F unit 25, the swivel I/F unit 26, and the light distribution pattern I/F unit 27 output via the connector terminals 13 the drive signals to the leveling actuators 3, the swivel actuators, and the light distribution pattern actuators 5 provided in the right and left headlamps R-HL and L-HL, respectively.

In the light distribution control ECU 10 of the ADB thus configured, the calculation part 29 of the microcomputer unit 12 performs prescribed calculation based on the CAN signal input to the CAN-I/F unit 23 and the sensor signals input to the sensor I/F unit 24, generates the respective control signals for the leveling control, the swivel control, and the light distribution pattern control, and outputs the generated control signals to the leveling I/F unit 25, the swivel I/F unit 26, and the light distribution pattern I/F unit 27, respectively. The leveling I/F unit 25 outputs the drive signal corresponding to the leveling control signal to the leveling actuators 3 to drive and control the same. Thus, the lamp light axes of the lamp units 2 are deflected in the vertical up and down direction. The swivel I/F unit 26 outputs the drive signal corresponding to the swivel control signal to the swivel actuators 4 to drive and control the same. Thus, the lamp light axes of the lamp units 2 are deflected in the horizontal right and left direction. The light distribution pattern I/F unit 27 outputs the drive signal corresponding to the light distribution pattern control signal to the light distribution pattern actuators 5 to drive and control the same. Thus, the shape of light emitted from the lamp units 2 is changed. Here, as described above, the light distribution pattern of the light applied from the lamp units 2 is changed when the shade disposed inside the lamp units 2 is switched.

Accordingly, when the light distribution pattern I/F unit 27 drives and controls the light distribution pattern actuators 5 based on the CAN signal and the sensor signals, the light distribution control ECU 10 switches the shape of a light distribution pattern formed by the lamp unit 2 between a light distribution pattern for a high beam and a light distribution pattern for a low beam. In addition, the light distribution control ECU 10 forms so-called a light distribution pattern for a single-side high beam in which an additional light distribution pattern is added to the left or right region of the lamp light axis in the upper region of a light distribution pattern for a low beam to form a light distribution pattern equivalent to a light distribution pattern for a high beam in one of the right and left regions. Concurrently with this, the leveling I/F unit 25 drives and controls the leveling actuators 3 to deflect the lamp light axes of the lamp units 2 in the vertical up and down direction, and besides this or without the leveling control, the swivel I/F unit 26 drives and controls the swivel actuators 4 to deflect the lamp light axes of the lamp units 2 in the horizontal right and left direction. Thus, light distribution control can be realized in which a light distribution pattern controlled by the light distribution pattern I/F unit 27 is deflected in at least one of the vertical up and down direction and the horizontal right and left direction, and the ADB is constructed as a light distribution control system.

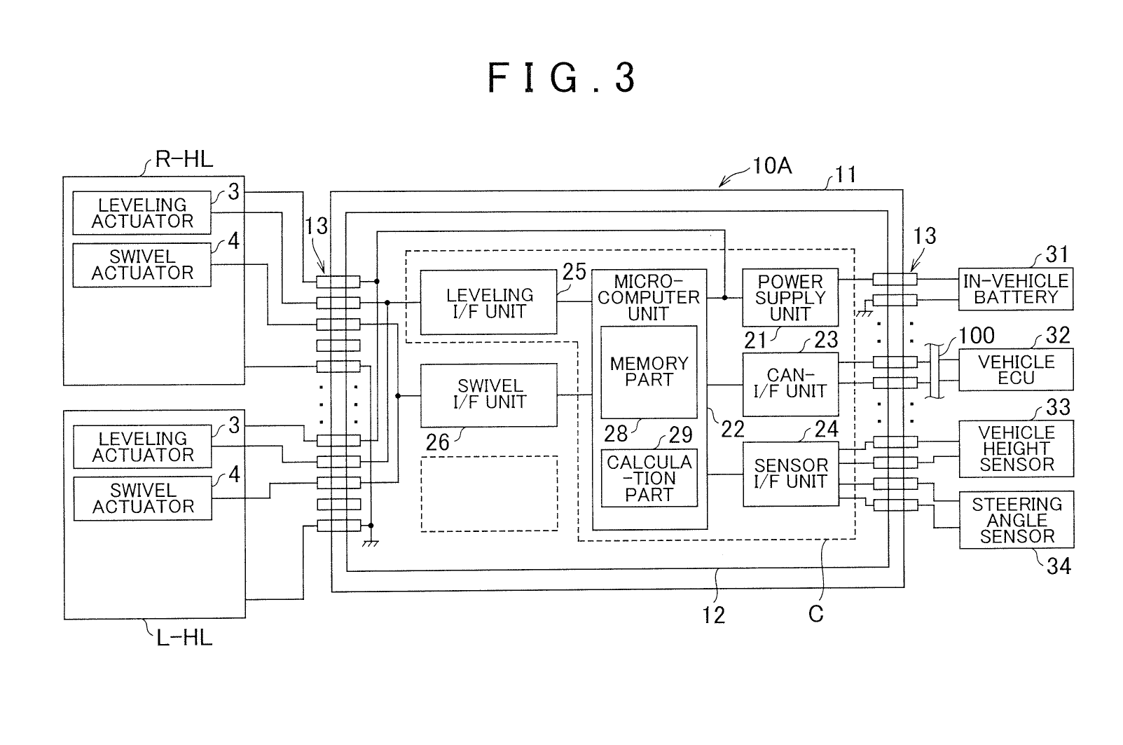

While, FIG. 3 is a system block diagram containing a light distribution control ECU 10A in a case in which the AFS that vertically and horizontally changes lamp light axes without controlling a light distribution pattern is constructed as a light distribution control system depending on a difference in the type and grade of a vehicle. As is the case with the ADB, the light distribution control ECU 10A is connected to the right and left headlamps R-HL and L-HL. However, the right and left headlamps R-HL and L-HL are not provided with the light distribution pattern actuators and are provided with only the leveling actuators 3 and the swivel actuators 4. In the light distribution control ECU 10A, a casing 11, a motherboard 12, and connector electrodes 13 are the same as those of the light distribution control ECU 10 of the ADB described above. In addition, a power supply unit 21, a microcomputer unit 22, a CAN-I/F unit 23, a sensor I/F unit 24, a leveling I/F unit 25, and a swivel I/F unit 26 which are mounted on the motherboard 12 are also the same as those of the light distribution control ECU 10 of the ADB described above. In other words, the light distribution control ECU 10A is so configured that only the light distribution pattern I/F unit 27 is eliminated from the light distribution control ECU 10 of the ADB, and the remaining units of the light distribution control ECU 10A are the same as those of the light distribution control ECU 10 of the ADB.

When the light distribution control ECU 10A of the AFS is manufactured, it is only necessary to prepare the casing 11, the motherboard 12, and the connector electrodes 13 that are the same as those of the light distribution control ECU 10 of the ADB and eliminate the step of mounting the light distribution pattern I/F unit 27 from the steps of mounting the respective units for manufacturing the ADB so as to mount the respective units on the motherboard 12. That is, it is only necessary to omit the mounting of an electronic component configuring the light distribution pattern I/F unit 27 on the motherboard 12. Therefore, it is not necessary to separately design and manufacture the light distribution control ECU 10A of the AFS, and it becomes possible to reduce a man hour for designing and manufacturing the light distribution control ECU 10A of the AFS and reduce a man hour for verification in the manufacturing step. In addition, when the external devices, i.e., the in-vehicle battery 31, the vehicle ECU 32, the vehicle height sensor 33, and the steering angle sensor 34 are electrically connected to the manufactured light distribution control ECU 10A and when the leveling actuators 3 and the swivel actuators 4 of the right and left headlamps R-HL and L-HL are connected to the manufactured light distribution control ECU 10A, it becomes possible to implement electrical connection by the connector electrodes 13 as is the case with the light distribution control ECU 10 of the ADB. Therefore, an operation for constructing the AFS is also facilitated.

In the light distribution control ECU 10A of the AFS thus configured, the microcomputer unit 22 generates control signals for the leveling control and the swivel control based on a CAN signal and sensor signals. Then, the leveling I/F unit 25 outputs a drive signal to the leveling actuators 3 based on the leveling control signal to drive and control the leveling actuators 3 and deflect the lamp light axes of the lamp units 2 in the vertical up and down direction. Besides this or without the leveling control, the swivel I/F unit 26 outputs a drive signal to the swivel actuators 4 based on the swivel control signal generated by the microcomputer unit 22 to drive and control the swivel actuators 4 and deflect the lamp light axes of the lamp units 2 in the horizontal right and left direction. Thus, the AFS control is realized, and the light distribution control system of the AFS is constructed.

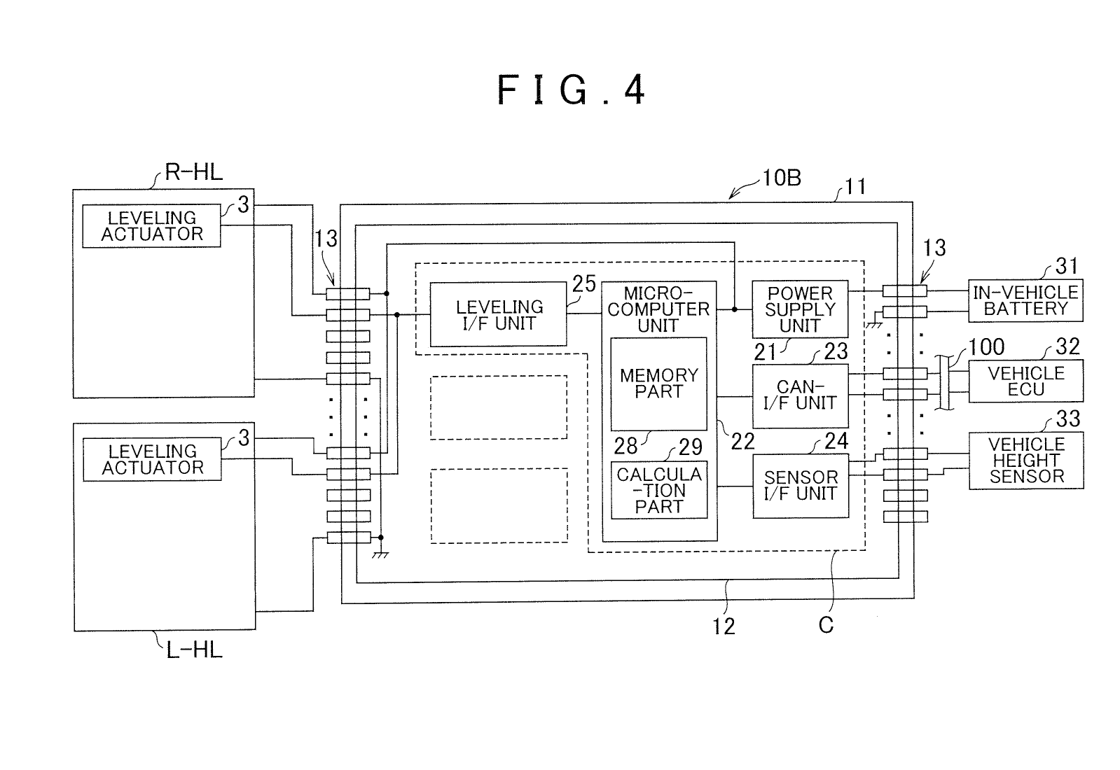

Moreover, FIG. 4 is a system block diagram in a case in which the ALS is constructed as a light distribution control system depending on a difference in the type and grade of a vehicle. Although a light distribution control ECU 10B is connected to the right and left headlamps R-HL and L-HL, only the leveling actuators 3 are disposed in the right and left headlamps R-HL and L-HL here. In the light distribution control ECU 10B, a casing 11, a motherboard 12, and connector electrodes 13 are the same as those of the respective light distribution control ECUs 10 and 10A of the ADB and the AFS. In addition, a power supply unit 21, a microcomputer unit 22, a CAN-I/F unit 23, a sensor I/F unit 24, and a leveling I/F unit 25 mounted on the motherboard 12 of the light distribution control ECU 10B are the same as those of the respective light distribution control ECUs 10 and 10A of the ADB and the AFS. In other words, the light distribution control ECU 10B is so configured that the light distribution pattern I/F unit 27 and the swivel I/F unit 26 are eliminated from the light distribution control ECU 10 of the ADB, i.e., the swivel I/F unit 26 is eliminated from the light distribution control ECU 10B of the AFS, and the remaining units of the light distribution control ECU 10B are the same as those of the light distribution control ECUs 10 and 10A of the ADB and the AFS.

Accordingly, when the light distribution control ECU 10B of the ALS is manufactured, it is only necessary to prepare the casing 11, the motherboard 12, and the connector electrodes 13 that are the same as those of the light distribution control ECU 10 of the ADB and eliminate the steps of mounting the light distribution pattern I/F unit 27 and the swivel I/F unit 26 from the steps of mounting the respective units for manufacturing the light distribution control ECU 10 of the ADB so as to mount the respective units on the motherboard 12. Therefore, it becomes possible to reduce a man hour for designing and manufacturing the light distribution control ECU 10B of the ALS and reduce a man hour for verification in the manufacturing step. In addition, when the external devices, i.e., the in-vehicle battery 31, the vehicle ECU 32, and the vehicle height sensor 33 are electrically connected to the manufactured light distribution control ECU 10B and when the manufactured light distribution control ECU 10B is connected to the leveling actuators 3 of the right and left headlamps R-HL and L-HL, it becomes possible to use the same connector electrodes 13 as those of the light distribution control ECUs 10 and 10A of the ADB and the AFS. Therefore, an operation for constructing the ALS is also facilitated. Note that the ALS may not have the steering angle sensor 34 connected thereto unlike the ADB and the AFS, and FIG. 4 illustrates a configuration in which the steering angle sensor 34 is not connected to the light distribution control ECU 10B.

In the light distribution control ECU 10B of the ALS thus configured, the microcomputer unit 22 generates a control signal for the leveling control based on a CAN signal and sensor signals. Then, the leveling I/F unit 25 generates a drive signal based on the control signal and drives and controls the leveling actuators 3 to deflect the lamp light axes of the lamp units 2 in the vertical up and down direction. Thus, the ALS is constructed as a light distribution control system.

As is seen from the above description, when the ADB, the AFS, and the ALS are respectively constructed as the light distribution control systems, the light distribution control ECUs 10, 10A, and 10B of the respective light distribution control systems may be manufactured using the common, i.e., the same casing 11, motherboard 12, and connector electrodes 13. In addition, the power supply unit 21, the microcomputer unit 22, the CAN-I/F unit 23, and the sensor I/F unit 24 mounted on the motherboard 12 may have the same configuration. Moreover, since the leveling I/F unit 25 for the ALS is also used for the ADB and the AFS, it may have the same configuration. Accordingly, if the motherboard 12, on which the units surrounded by a dashed line C in FIGS. 2, 3, and 4, i.e., the power supply unit 21, the microcomputer unit 22, the CAN-I/F unit 23, the sensor I/F unit 24, and the leveling I/F unit 25 are mounted as common units C, is designed and manufactured in advance, the light distribution control ECU 10B of the ALS may be configured only by directly using the motherboard 12. In addition, the light distribution control ECU 10A of the AFS may be configured if the swivel I/F unit 26 is additionally mounted on the motherboard 12 as a dedicated unit, and the light distribution control ECU 10 of the ADB may be configured if the light distribution pattern I/F unit 27 is mounted on the motherboard 12 as yet another dedicated unit. Thus, it becomes possible to make the plurality of units configuring the light distribution control ECUs be common, facilitate the designing and manufacturing of the light distribution control ECUs, and reduce the costs of the light distribution control ECUs.

In addition, when the respective light distribution control ECUs 10, 10A, and 10B thus configured are assembled into a vehicle, it becomes possible to assemble them based on the same assembling structure and the same assembling step regardless of the difference between the respective light distribution control systems of the ALS, the AFS, and the ADB and realize the simplification of designing the body of the vehicle and the easiness of the assembling operation since the casing 11 is made common. Moreover, when the CAN signal line 100 and the various sensors are connected to the assembled light distribution control ECUs and when the respective actuators 3, 4, and 5 of the right and left headlamps R-HL and L-HL are connected to the light distribution control ECUs, it is only necessary to make connections to the same electrodes using the connector electrodes 13 under the same standard provided in the light distribution control ECUs 10, 10A, and 10B regardless of the difference between the light distribution control systems. Accordingly, the connecting operation is facilitated, and the occurrence of connection errors may be prevented. For example, the above is also effective for a case in which a light distribution control ECU is replaced together with headlamps when a light distribution control system is upgraded in the same vehicle.

The embodiment describes an example in which the power supply unit 21, the microcomputer unit 22, and the I/F units 23 to 27 are configured in such a way that electronic components configuring the respective units are mounted on the motherboard 12. However, it may be possible to segment the respective units into sub-units and mount the sub-units on the motherboard 12. For example, although not illustrated in the figures, electronic components configuring the respective units are mounted on small sub-boards to configure sub-units and the sub-boards are mounted on the motherboard 12. Particularly, if the light distribution pattern I/F unit 27 and the swivel I/F unit 26 used for the ADB are configured to be segmented into sub-units, the respective light distribution control ECUs of the ADB, the AFS, and the ALS may be manufactured depending on whether the sub-units are mounted or not. Therefore, the step of manufacturing the light distribution control ECUs may be greatly facilitated. Note that since the common units C, i.e., the power supply unit 21, the microcomputer unit 22, the CAN-I/F unit 23, the sensor I/F unit 24, and the leveling I/F 25 are essential for the respective light distribution control ECUs of the ALS, the AFS, and the ADB, electronic components configuring these units may be directly mounted on the motherboard 12 without being segmented into sub-units.

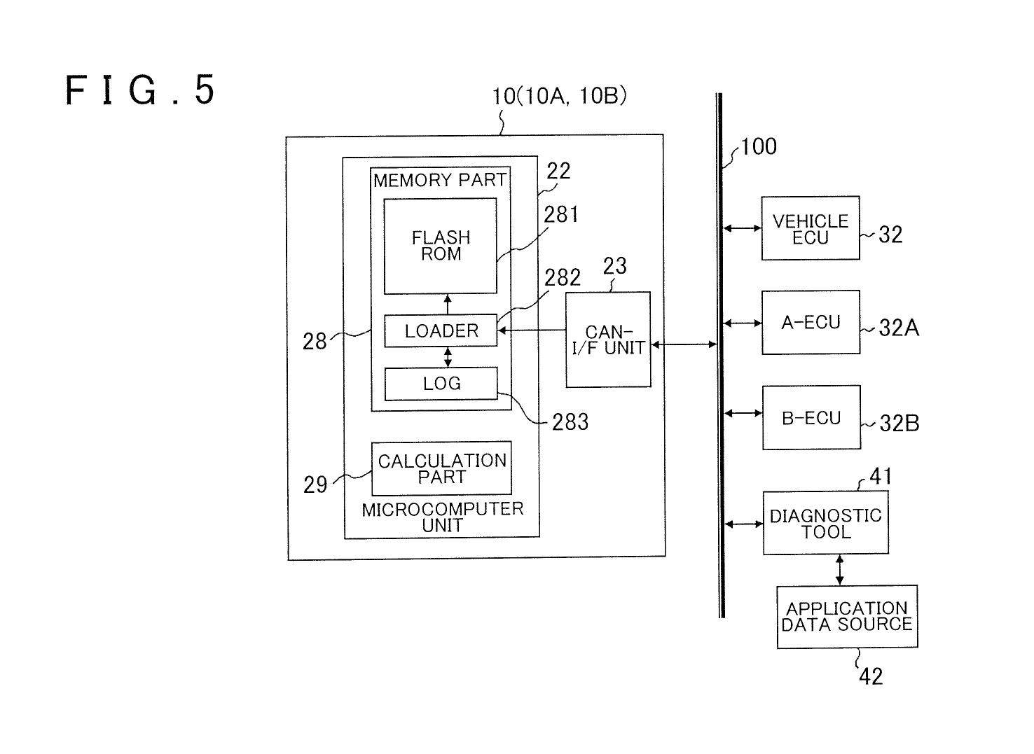

FIG. 5 is a block configuration diagram illustrating the connection structure between the detailed parts of the microcomputer unit 22 mounted on the light distribution control ECU 10 (ditto for the light distribution control ECUs 10A and 10B) and external devices connected to the light distribution control ECU 10. As described above, the microcomputer unit 22 includes the memory part 28 and the calculation part 29. The calculation part 29 performs calculation based on a CAN signal and sensor signals using an application stored in the memory part 28 to generate respective control signals for the leveling control, the swivel control, and the light distribution pattern control. In addition, the memory part 28 of the microcomputer unit 22 includes a memory 281 composed of a flash read-only memory (ROM), a loader (writing section) 282, and a log (recording section) 283. The loader 282 is connected to the CAN signal line 100 via the CAN-I/F unit 23. The CAN signal line 100 is connected to the vehicle ECU 32 that serves as an external device and ECUs that control other units of a vehicle, temporarily referred to as an A-ECU 32A and a B-ECU 32B here.

In addition, the CAN signal line 100 is connectable to a diagnostic tool 41 that serves as one of the external devices. The diagnostic tool 41 is configured as a vehicle diagnostic device and capable of reading any of various applications stored in an application data source 42 thereof and outputting the same to the CAN signal line 100. In addition, the loader 282 is capable of fetching an application output to the CAN signal line 100 via the CAN-I/F unit 23 and writing the same in the memory 281. That is, the loader 282 is capable of overwriting an application stored in the memory 281 with an application to update the same. The log 283 is capable of recording the information (writing date and time, application number, or the like) of a written application and is also capable of making a comparison with an application currently stored in the memory 281 while referring to the information of an application input via the CAN signal line 100.

The writing of an application into the memory 281 of the memory part 28 is generally performed in the following way. That is, an application is written into the memory 281 before the microcomputer unit 22 is assembled into the light distribution control ECU 10, and then the microcomputer unit 22 into which the application has been written is assembled into the light distribution control ECU 10. Alternatively, an application is written into the memory 281 before the light distribution control ECU 10 into which the microcomputer unit 22 has been assembled is assembled into a vehicle. Further, when an application is updated (rewritten) as the countermeasures against bugs, the upgrade, or the like of the application is required, the microcomputer unit 22 is detached from the light distribution control ECU 10 and the application is updated in the memory part 28 in the former case. In the latter case, the light distribution control ECU 10 is detached from a vehicle and the application is updated in the memory part 28. Alternatively, in the former case, the light distribution control ECU is replaced with one having a new application. Therefore, the operation of attaching and detaching the microcomputer unit 22 to and from the light distribution control ECU 10 and the operation of attaching and detaching the light distribution control ECU 10 to and from a vehicle become complicated, and operation time for updating an application is likely to be long.

In the embodiment, the microcomputer unit 22 is connected to the CAN signal line 100 via the CAN-I/F unit 23 of the light distribution control ECU 10. Therefore, at the update of an application, it is only necessary to connect the diagnostic tool 41 to the CAN signal line 100 in a state in which the light distribution control ECU 10 is disposed in a vehicle and transmit an update application from the application data source 42 to the CAN signal line 100 with the diagnostic tool 41. As a result, the update application is input to the microcomputer unit 22 via the CAN-I/F unit 23 of the light distribution control ECU 10, and the application is rewritten by the loader 282 in the memory 281 as described above. Since the diagnostic tool 41 is only required to output an application to the CAN signal line 100, an existing one may be used as it is. In addition, since the light distribution control ECU 10 is only required to be connected to the CAN signal line 100, it becomes possible to update an application without detaching the light distribution control ECU 10 from a vehicle or detaching the microcomputer unit 22 from the light distribution control ECU 10. Accordingly, since the operation of detaching the light distribution control ECU 10 and the microcomputer unit 22 and the operation of reassembling the detached light distribution control ECU 10 and the microcomputer unit 22 become unnecessary, it becomes possible to simplify the operations and reduce time for updating an application.

The embodiment describes an example in which the light distribution control system of any of the ALS, the AFS, and the ADB is selected and applied to a vehicle as a light distribution control system for the headlamps. However, when a light distribution control ECU including any of the ALS and the AFS is configured as a light distribution control system applied to a middle-grade vehicle, it may be possible to prepare a motherboard corresponding to the AFS and selectively mount a leveling I/F unit and a swivel I/F unit on the motherboard. Moreover, when a system other than the ALS, the AFS, and ADB is added as a light distribution control system applied to a high-grade vehicle, a motherboard may be so configured as to be capable of mounting an I/F unit corresponding to the added system.

In addition, the embodiment is so configured that the motherboard is formed to be separated from the casing and the motherboard mounting the respective units is disposed inside the casing. However, it may be possible to directly mount the respective units, i.e., the microcomputer unit and the respective I/F units on the casing. In other words, it may be possible to integrate the motherboard into the casing or integrate a wiring pattern into the casing without the motherboard and mount the respective units on the wiring pattern. Thus, since the motherboard and the connector electrodes that connect the motherboard and the casing to each other become unnecessary, it becomes effective to make the components or the respective units of the light distribution control ECU be common to a greater extent and simplify the structure of the light distribution control ECU.

Note that when the dedicated unit is electively mounted on the light distribution control ECU in the embodiment of the invention, an unmounted dedicated unit indicates that the dedicated unit is configured not to perform the light distribution control. In other words, the unmounted dedicated unit may be configured not to operate even when it is mounted on the motherboard. Accordingly, for example, the embodiment may be so configured that the application of the microcomputer unit 22 is changed and the dedicated units such as the swivel control I/F unit and the light distribution pattern I/F unit do not substantially operate in a state in which the common units including the leveling I/F unit and all the dedicated units (the swivel I/F unit and the light distribution pattern I/F unit) are mounted on the motherboard. Under such a configuration, it is only necessary to manufacture a motherboard common to all the light distribution control systems and a light distribution control ECU configured to include the motherboard. That is, it is only necessary to manufacture one type of light distribution control ECU, and the designing and manufacturing of the light distribution control ECU is greatly facilitated.

In addition, the CAN signal line is not necessarily used to update the application of the memory part of the microcomputer unit. That is, if there are extra connector electrodes, a direct access to the microcomputer unit via the connector electrodes may be allowed. In this case, it becomes possible to connect the diagnostic tool to the connector electrodes and directly update the application of the memory part.

The embodiment of the invention may be employed in light distribution control systems for the vehicular headlamp that performs light distribution control with a light distribution control ECU.

As described above, an aspect of the invention relates to a light distribution control system for a vehicular headlamp including: a headlamp configured such that light distribution of the headlamp can be controlled based on a plurality of modes of light distribution control; and a light distribution control electronic control unit configured to control the light distribution of the headlamp based on at least one of the plurality of modes of light distribution control. The light distribution control electronic control unit is configured such that a common unit commonly used in the plurality of modes of the light distribution control and a dedicated unit exclusively used in at least one of the plurality of modes of the light distribution control can be mounted.

The light distribution control electronic control unit may include a casing formed in accordance with a prescribed standard, and only the common unit and the dedicated unit exclusively used in a prescribed mode of the light distribution control are disposed inside the casing. For example, the common unit may include a microcomputer unit and a leveling control unit configured to control a lamp light axis of the headlamp to be deflected in a vertical direction, and the dedicated unit may include at least one of a swivel control unit configured to control the lamp light axis to be deflected in a horizontal direction and a light distribution pattern control unit configured to control a shape of a distribution pattern of light radiated from the headlamp. In this case, the plurality of modes of the light distribution control may include light distribution control based on an auto leveling system in which only the common unit is mounted on the light distribution control electronic control unit, light distribution control based on an adaptive front-lighting system in which the common unit and the swivel control unit are mounted on the light distribution control electronic control unit, and light distribution control based on an adaptive driving beam in which the common unit, the swivel control unit, and the light distribution pattern control unit are mounted on the light distribution control electronic control unit.

The common unit may include a storage part configured to store software for performing the light distribution control, and the software stored in the storage part may be updated when the common unit is connected to an outside of the light distribution control electronic control unit. The software stored in the storage part may be updated in a state in which the common unit and the dedicated unit are disposed inside the light distribution control electronic control unit and the light distribution control electronic control unit is mounted in a vehicle. Further, the common unit may be connected to an external device via a vehicle signal line, and the software stored in the storage part may be updated using prescribed software transmitted from the external device to the common unit.

According to the aspect of the invention, a plurality of different modes of the light distribution control can be realized without mounting or only by selectively mounting a dedicated unit on a light distribution control ECU having the same configuration. Therefore, it is not necessary to design and manufacture light distribution control ECUs having different configurations corresponding to the plurality of different modes of the light distribution control, and thus the light distribution control ECUs can be manufactured easily and at low cost.

According to the aspect of the invention, since software stored in a storage part is updated when the common unit is connected to the outside of the light distribution control ECU, it becomes possible to update the software stored in the storage part in a state in which the common unit and the dedicated unit are mounted inside the light distribution control ECU and the light distribution control ECU is mounted on a vehicle. Therefore, software may be updated without detaching the common unit from the light distribution control ECU or without detaching the light distribution control ECU from a vehicle, and thus the simplification and cost reduction of operations may be realized.

What is claimed is:

1. A light distribution control system for a vehicular headlamp, comprising:
a headlamp configured such that light distribution of the headlamp can be controlled based on a plurality of modes of light distribution control; and
a light distribution control electronic control unit configured to control the light distribution of the headlamp based on at least one of the plurality of modes of light distribution control, wherein
the light distribution control electronic control unit is configured such that a common unit commonly used in the plurality of modes of the light distribution control and a dedicated unit exclusively used in at least one of the plurality of modes of the light distribution control can be mounted.

2. The light distribution control system according to claim 1, wherein:
the light distribution control electronic control unit includes a casing formed in accordance with a prescribed standard; and
only the common unit and the dedicated unit exclusively used in a prescribed mode of the light distribution control are disposed inside the casing.

3. The light distribution control system according to claim 1, wherein:
the common unit includes a microcomputer unit and a leveling control unit configured to control a lamp light axis of the headlamp to be deflected in a vertical direction; and
the dedicated unit includes at least one of a swivel control unit configured to control the lamp light axis to be deflected in a horizontal direction and a light distribution pattern control unit configured to control a shape of a distribution pattern of light radiated from the headlamp.

4. The light distribution control system according to claim 3, wherein:
the plurality of modes of the light distribution control includes light distribution control based on an auto leveling system in which only the common unit is mounted on the light distribution control electronic control unit, light distribution control based on an adaptive front-lighting system in which the common unit and the swivel control unit are mounted on the light distribution control electronic control unit, and light distribution control based on an adaptive driving beam in which the common unit, the swivel control unit, and the light distribution pattern control unit are mounted on the light distribution control electronic control unit.

5. The light distribution control system according to claim 1, wherein:
the common unit includes a storage part configured to store software for performing the light distribution control; and
the software stored in the storage part is updated when the common unit is connected to an outside of the light distribution control electronic control unit.

6. The light distribution control system according to claim 5, wherein the software stored in the storage part is updated in a state in which the common unit and the dedicated unit are disposed inside the light distribution control electronic control unit and the light distribution control electronic control unit is mounted in a vehicle.

7. The light distribution control system according to claim 5, wherein:
the common unit is connected to an external device via a vehicle signal line; and
the software stored in the storage part is updated using prescribed software transmitted from the external device to the common unit.
